(19) United States
(12) Patent Application Publication
(10) Pub. No.: US 2026/0305694 A1
(43) Pub. Date: Oct. 8, 2026

(54) An Aerosol Generation Consumable with a Rounded Periphery

(71) Applicant: JT INTERNATIONAL SA, Geneva (CH)

(72) Inventor: Grzegorz Aleksander Pilatowicz, Grens (CH)

(73) Assignee: JT INTERNATIONAL SA, Geneva (CH)

(21) Appl. No.: 19/485,580

(22) PCT Filed: May 28, 2024
(86) PCT No.: PCT/EP2024/064652

§ 371 Date: Nov. 18, 2025

(30) Foreign Application Priority Data
Jun. 1, 2023 (EP) 23176807.8

(51) Int. Cl. A24F 40/42; A24F 40/20; A24F 40/46; H05B 3/03

(52) U.S. Cl. CPC A24F 40/42; A24F 40/20; A24F 40/46; H05B 3/03

(57) ABSTRACT

Please delete the Abstract as originally filed and substitute the following Abstract therefor: An aerosol generation consumable for use in an aerosol generation device includes aerosol precursor material; and one or more electrical conductors in the aerosol precursor material, wherein the aerosol generation consumable has a rounded periphery, and wherein the aerosol generation consumable is disc-shaped. A system includes an aerosol generation device comprising at least one electrode configured to provide electrical power, and the aerosol generation consumable configured to receive the provided electrical power.

The present disclosure relates to an aerosol generation consumable, a system comprising an aerosol generation device and an aerosol generation consumable and a method of generating an aerosol.

### BACKGROUND

Various devices and systems are available that heat aerosol precursor material to release aerosol/vapour for inhalation, rather than relying on burning the material. However, such devices require a heater to be part of the device and hence the device requires adequate insulation to prevent a user from being exposed to the high heater temperatures, which leads to additional complexity and cost in the device.

A challenge associated with heating aerosol precursor material rather than burning it is that there is an increased time to generate the aerosol from the aerosol precursor material. A further challenge is that once the aerosol precursor material is heated to the volatilisation temperature, aerosol may be continuously generated even when a user is not inhaling, thereby wasting energy and the aerosol precursor material.

Some traditional aerosol generation devices use resistive heaters to generate aerosol from aerosol generation consumable. However, resistive heaters require a good thermal contact between the heater and the aerosol generation consumable to be heated in order to generate a sufficient amount of aerosol. As such, relatively large resistive heaters are required that have a relatively large contact area between the resistive heater and the aerosol generation consumable. Further, resistive heaters will often require cleaning.

It is the object of the invention to overcome at least one of the above referenced problems, or to provide an alternative solution.

### SUMMARY

According to the present disclosure there is provided an aerosol generation consumable including the features as set out in the claims.

In a first example, there is provided an aerosol generation consumable for use in an aerosol generation device, the aerosol generation consumable comprising: aerosol precursor material; and one or more electrical conductors in the aerosol precursor material, wherein the aerosol generation consumable has a rounded periphery.

This aerosol generation consumable format improves the convenience and experience for the consumers. The aerosol generation consumable with a rounded periphery reduces potential risks of unwanted experience (such us breaking of the consumable in an oven and the necessity to remove the remaining part from the heating chamber using special tool). This is especially prevalent when the aerosol generation consumable is disc shaped.

Further, the aerosol generation consumable enables device and package of consumables size reduction, whilst maintaining a high level of aerosol generation due to the one or more electrical conductors being present in the aerosol precursor material.

Furthermore, this concept helps to improve aerosol generation consumable removal experience which could be done even without touching and it requires significantly less thermal insulation thanks to application of the conductive aerosol generation consumable.

The rounded shape of the consumable helps to provide higher level of convenience for the consumer. In this case, it does not matter how the consumer grabs/removes the consumable from the packaging, it always will fit well in the aerosol generation device and work well.

In addition, having a rounded periphery aids with the mechanical strength of the consumables (e.g., reduces the likelihood of breakages). It may also ensure good alignment/fit with the aerosol generation device.

In one example, the aerosol generation consumable comprises one or more electrical contacts configured to electrically couple to electrodes of said aerosol generation device. The one or more electrical contacts may lead to a more efficient electricity transfer from the electrodes into the consumable.

In one example, the one or more contacts are arranged on a part of a periphery of the consumable. Arranging the one or more contacts on a part of the periphery enables electrodes to be provided to a side of said consumable, which may result in an efficient use of space within the device.

In one example, the one or more electrical contacts are arranged on a planar surface of the aerosol precursor material. This arrangement means that the electrodes of the device may effectively sandwich (to some extent) the aerosol generation consumable. One or more electrical contacts on a planar surface provides a higher contact surface area. Further, higher pressure may be achieved to ensure better electrical contact and less total/equivalent electrical resistance of the interface. Also, a planar surface will be more robust against ageing, dirtiness, and presence of some residues on the consumable.

In one example, the one or more electrical contacts comprises a first sheet on a first face of the aerosol precursor material and a second sheet arranged on a second face of the aerosol precursor material.

One or more of the first sheet and the second sheet comprises one or more openings. Providing one or more openings in the first sheet and/or second sheet means that generated aerosol may flow through the first sheet and/or the second sheet means that the generated aerosol may flow in a desired direction in the device. That is to say that less aerosol will flow out of the side (also called the periphery) of the aerosol generation consumable, which may lead to more condensation within the device.

In one example, the one or more electrical contacts comprises a first electrical contact and a second electrical contact. The aerosol generation consumable may comprise an electrical insulator located at least part way between the first electrical contact and the second electrical contact. The electrical insulator reduces the likelihood of electric power passing straight from one electrode to the other, for example due to insertion error or manufacturing tolerances, which may cause a short circuit in the device. In addition, the electrical insulator encourages the electrical power to flow through more of the aerosol precursor material, in use.

The electrical insulator may be paper based. Paper materials are used significantly in this industry and are relatively inexpensive and easy to use.

In one example, the aerosol generation consumable is disc-shaped. Having a disc-shaped consumable leads to space-saving efficiencies for the consumable, especially considering that the consumable includes one or more electrical conductors located within it and so there is not a requirement for separate heating means.

In one example, the aerosol generation consumable is a polygon shaped with rounded corners. This shape offers a blend of distinct ‘sides’ which might help for positioning or handling, yet the rounded angles aid in preventing catching or snagging of the consumable.

In one example, a thickness of the aerosol generation consumable is less than a width of the aerosol generation consumable. This arrangement leads to a more stackable consumable. Further, it is easier for the consumable itself to be stored within a storage section of the aerosol generation device.

In one example, there is provided plurality of aerosol generation consumables arranged in a stacked configuration. Having the consumables in a stacked configuration means that they may be efficiently stored in packaging to be carried around by a user or efficiently stored within the device itself.

In one example, there is provided a system comprising an aerosol generation device comprising at least one electrode configured to provide electrical power; and the aerosol generation consumable according to any one of the preceding claims. Only one electrode may be used as the aerosol generation consumable may be in contact with a grounded element. In some examples, the aerosol generation consumable may be simply connected to a grounded element and so only a single electrode is required (in addition to the grounded element) to complete the circuit and provide an electric current through the aerosol generation consumable. In other examples, the grounded element referenced above is considered to be an electrode and so the aerosol generation device comprises a pair of electrodes.

That is to say that the at least one electrode may comprise a pair of electrodes.

In one example, there is provided a method of generating an aerosol comprising: situating the aerosol generation consumable according to any of the claims in electrical contact with the electrodes of an aerosol generation device; and providing electrical power to the aerosol generation consumable.

Different combinations of the above referenced features may be combined together in various combinations.

### BRIEF DESCRIPTION OF THE DRAWINGS

Examples of the present disclosure will now be described with reference to the accompanying drawings.

FIG. 1 is a schematic cross-sectional view of an aerosol generation consumable;

FIG. 2 is a schematic cross-sectional view of an aerosol generation consumable;

FIG. 3A shows a schematic cross-sectional view of an aerosol generation consumable between electrodes;

FIG. 3B shows a schematic plan view of an aerosol generation consumable;

FIG. 3C shows a schematic side view of an aerosol generation consumable between electrodes;

FIG. 3D shows a schematic side view of an aerosol generation consumable with electrodes electrically coupled to the periphary;

FIG. 4A shows a schematic plan view of an aerosol generation consumable;

FIG. 4B shows a schematic plan view of an aerosol generation consumable;

FIG. 4C shows a schematic plan view of an aerosol generation consumable;

FIG. 4D shows a schematic plan view of an aerosol generation consumable;

FIG. 4E shows a schematic plan view of an aerosol generation consumable;

FIG. 5 is a schematic cross-sectional view of an aerosol generation device with a consumable inserted therein; and

FIG. 6 is a flow chart of a method of generating an aerosol.

### DETAILED DESCRIPTION

As used herein, the term “aerosol precursor material”, “vapour precursor material” or “vaporizable material” are used synonymously and refer to a material that releases aerosol when heated. The aerosol precursor material may be a solid material and may comprise nicotine and/or tobacco and a vaporising agent. The aerosol precursor material is configured to release an aerosol when heated or otherwise mechanically stimulated (such as by vibrations). Tobacco may take the form of various materials such as shredded tobacco, granulated tobacco, tobacco leaf and/or reconstituted tobacco. Nicotine may be in the form of nicotine salts. Suitable vaporising agents include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin.

An aerosol generation device is configured to aerosolise an aerosol precursor material without combustion in order to facilitate delivery of an aerosol to a user. Furthermore, and as is common in the technical field, the terms “vapour” and “aerosol”, and related terms such as “vaporize”, “volatilize” and “aerosolise”, may generally be used interchangeably.

As used herein, the term “aerosol generation device” is synonymous with “aerosol generating device” or “device”. The device may be portable. “Portable” may refer to the device being for use when held by a user. The device may be adapted to generate a variable amount of aerosol, which can be controlled by a user input.

There is provided an aerosol generation consumable that has a rounded shape that includes one or more electrical conductors therein. The presence of the one or more electrical conductors within the aerosol generation consumable means that aerosol may be generated more efficiently and faster when compared to traditional external heaters. Surprisingly, providing a “conductive” aerosol generation consumable comprising one or electrical conductors within aerosol precursor material means together with a rounded periphery leads to synergistic effects. For example, the shape of the consumable can be matched to the shape of the electrodes of the device to provide a more efficient electric power transfer between the electrodes of the device and the consumable, leading to a more efficient transfer to electric power to the consumable. In addition, the fact that the “conductive” consumables are more efficient at generating an aerosol means that they can be made relatively smaller in size and so multiple consumables may be stored within the device. Having a rounded periphery on the consumable is beneficial in this case as it is more conveniently stored within the device and less likely to be subject to high stresses when loading/unloading the consumable between the electrodes of the device and so will be less likely to break or catch/get stuck within the chamber or storage region of the aerosol generation device.

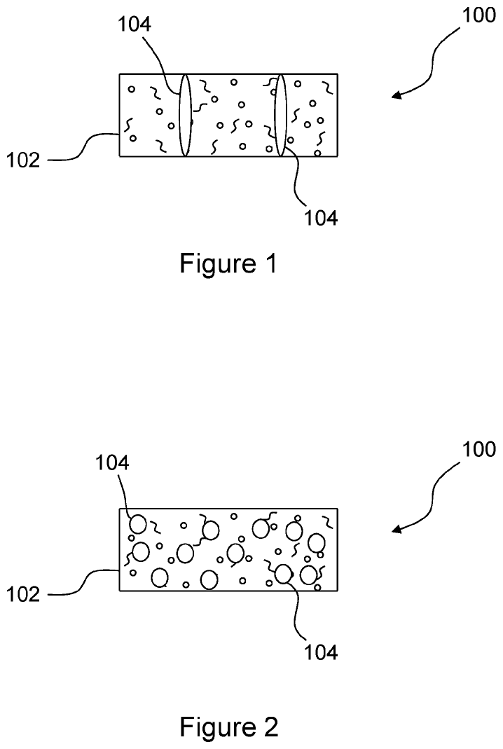

FIG. 1 shows a schematic example of an aerosol generation consumable 100. The aerosol generation consumable 100 includes a an aerosol precursor material 102 and one or more electrical conductors 104. The aerosol precursor material 102 is configured to release an aerosol when heated. In one example, the aerosol precursor material 102 is a solid aerosol precursor material or a semi-solid aerosol precursor material. That is the aerosol precursor material is not configured to flow in an unheated state.

The one or more electrical conductors 104 are configured to conduct electricity received from an aerosol generation device, as will be described in more detail later. The size and arrangement of the one or more electrical conductors 104 is set such that as an electric power is passed through them, the temperature of the electrical conductors 104 increases to heat the aerosol precursor material. In other words, the aerosol precursor material 102 includes one or more electrical conductors at least partially embedded within it to conduct electricity. The one or more electrical conductors 104 may comprise a plurality of discrete electrical conductors distributed throughout the aerosol precursor material 102. The aerosol generation consumable 100 can be considered to be a conductive aerosol generation consumable. Providing one or more electrical conductors within a aerosol precursor material significantly reduces the time taken for aerosol to be generated for a user, in use.

The one or more electrical conductors 104 may be present in a one or more dedicated heating layers, as shown in FIG. 1. The one or more dedicated heating layers may be regions in which there is a high level of electrical conductors or a relatively higher level of conduction due to the nature or number of electrical conductors 104.

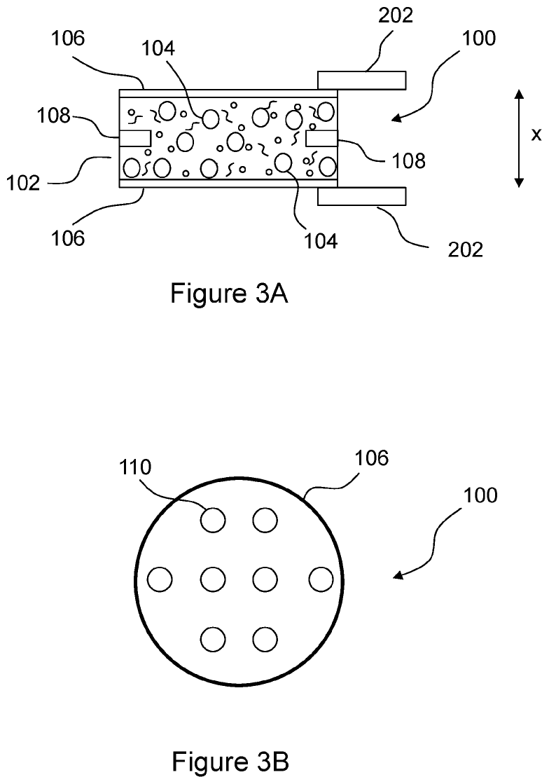

In other examples, as shown in FIG. 2, electrical conductors 104 are distributed throughout the aerosol precursor material 102.

The one or more electrical conductors 104 may be present in particulate form in the aerosol precursor material 102 (note that FIGS. 1 and 2 are schematic examples and not shown to scale). The one or more electrical conductors 104 may take the form of graphite or charcoal particles. The material may take the form of powder, loose or agglomerated particles. It is also conceivable to use other conductive materials which are approved in particular at least in the tobacco industry or food industry.

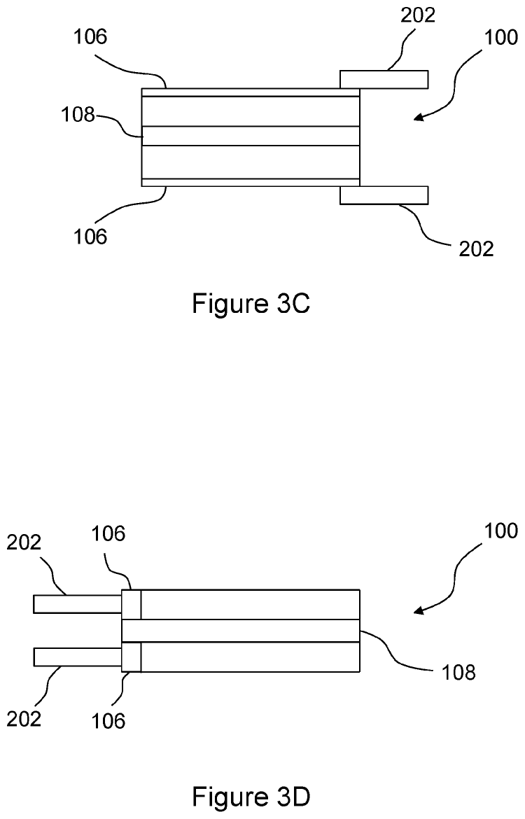

FIG. 3A shows a schematic cross section of an aerosol generation consumable 100 between two electrodes 202 (or one electrode and a grounded element). The aerosol generation consumable 100 is configured to electrically connect electrodes 202 that it is located between. As will be described later, the electrodes 202 are part of an aerosol generation device 200. In this case, providing electric power to the at least one electrode 202 is used interchangeably with providing electrical power to the aerosol generation consumable 100.

In one example, the at least one electrode 202 includes a first electrode and a second electrode that are spaced apart from each other by a predetermined distance indicated by “x” on FIG. 3A. In other examples, the at least one electrode 202 includes a first set of electrodes and a second set of electrodes. The first set of electrodes are space apart from the second set of electrodes by a predetermined distance, which is preferably substantially similar to a thickness of the aerosol generation consumable 100.

The aerosol generation consumable 100 may include one or more electrical contacts 106 configured to electrically couple to electrodes 202 of said aerosol generation device 200. In other example, the consumable 100 does not include electrical contacts that are distinct from the one or more electrical conductors 104 (e.g., the one or more electrical conductors may be electrically coupled directly with the electrodes themselves).

In FIG. 3A, the one or more electrical contacts 106 are located on a surface of the aerosol precursor material 102. For example, the aerosol precursor material 102 may include two planar surfaces and the one or more electrical contacts 106 are located on these. That is to say that there may be a first electrical contact provided on a first planar surface of the aerosol precursor material 102 and a second electrical contact provided on a second planar surface of the aerosol precursor surface. The one or more electrical contacts 106 may be formed of any material that is a good conductor of electricity, such as aluminium, carbon or the like.

The one or more electrical contacts 106 may comprise a first metal sheet on a first face of the aerosol precursor material 102 and a second metal sheet arranged on a second face of the aerosol precursor material 102.

FIG. 3B shows a schematic plan view of an aerosol generation consumable 100 including a perforated electrical contact 106. In practice, a part of the aerosol precursor material 102 may extend out beyond the extent of the electrical contact 106, but for clarity, this has not been shown in FIG. 3B. The perforations 110 (also known as openings) in the electrical contact 106 arranged on a surface of the aerosol precursor material 102 may provide a path for aerosol to flow from the aerosol precursor material 102 through the planar surface. In other examples, the generated aerosol may simply flow through a side of the consumable 100. The perforation 110 may be pre-made or could be done by the consumer using cheese grate. The perforations 110 allow generated aerosol to flow in the desired direction with reduced flow out of the periphery of the consumable that may create unwanted condensation and unwanted cleaning effort for the consumer within the aerosol generation device 100.

FIG. 3C shows a schematic side view of the consumable 100 shown in FIG. 3A. As shown in these examples, the aerosol generation consumable 100 may include an electrical insulator 108 located at least part way between the electrical contacts 106. That is to say that the one or more electrical contacts 106 may include a first electrical contact and a second electrical contact, wherein the aerosol generation consumable 102 comprises an electrical insulator 108 located at least part way between the first electrical contact and the second electrical contact. The purpose of the electrical insulator 108 is to provide an additional barrier between the electrodes 202, in use. That is to say that when the aerosol generation consumable 100 is in position and in electrical contact with the electrodes 202, the electrical insulator 108 provides some protection against the electrodes 202 coming into direct contact with each other and encourages the electric current/power to flow through the aerosol generation consumable, in use.

In one example, the electrical insulator 108 is substantially ring shaped. That is to say that the electrical insulator may be annular and have an opening extending through the middle. This shape means that electric power will flow from one electrode to the other through substantially the majority of the aerosol precursor material 102 to aerosolise the majority of the aerosol precursor material 102.

The electrical insulator 108 may compensate for the manufacturing tolerances and positioning tolerances of the aerosol generation consumable 100 in the aerosol generation device 200.

In one example, the electrical insulator 108 is paper based. In other examples, the electrical insulator is a polymer-based material e.g., polypropylene or non-woven material.

FIG. 3D shows an alternative example of the aerosol generation consumable 100. In this other example, the one or more electrical contacts 106 are arranged on a part of a periphery of the consumable 100. In this case, the electrodes 202 of the device 200 are configured to electrically couple with the one or more electrical contacts on the periphery of the consumable 100. Again, in this example the consumable 100 may include an electrical insulator 108 that extends at least partially between a first electrical contact and a second electrical contact (of the one or more electrical contacts). In some examples, one electrode 202 may be configured to electrically couple with a face of the aerosol generation consumable 100 and another electrode 202 (or grounded element) may be configured to electrically couple with a periphery of the aerosol generation consumable 100.

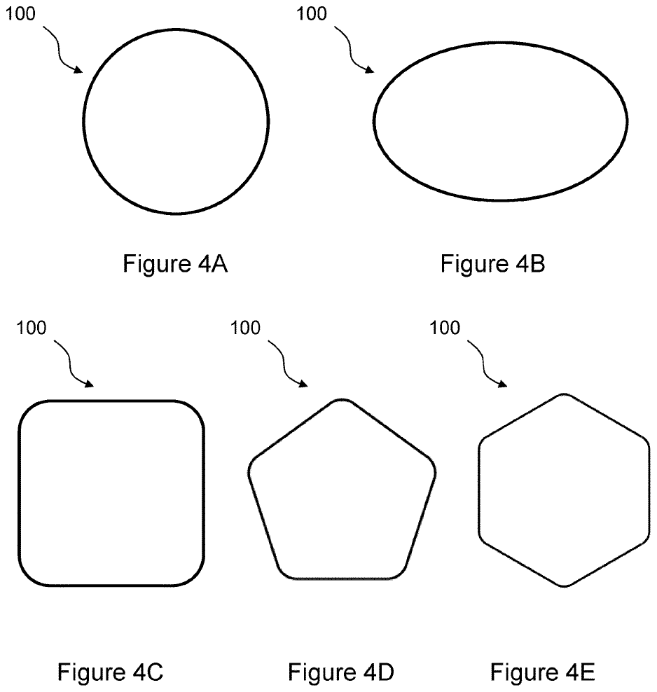

FIGS. 4A to 4E show some example shapes of the aerosol generation consumable 100. Each of the examples all relate to the aerosol generation consumable 100 having a rounded periphery. As indicated above, as the aerosol generation consumable 100 has a rounded periphery, it will be storable in a more efficient manner such that it will be less prone to high stresses when moved as it will be less likely to “catch” on another element when being moved into or out contact with the electrodes 202 of the aerosol generation device 200. In examples, a height (also referred to as a thickness) of the aerosol generation consumable 100 is less than a width of the aerosol generation consumable 100. For example, the width may be a diameter of the aerosol generation consumable 100. In on example, the height of the aerosol generation consumable 100 is between 1 mm to 3 mm, more preferably 2 mm. In some examples, a width of the aerosol generation consumable 100 may be between 5 mm to 12 mm, more preferably 7 mm to 10 mm, more preferably 8.5 mm.

The aerosol generation consumable 100 shown in FIG. 4A is disc-shaped or substantially disc-shaped. This shape of aerosol generation consumable will be the least prone to breakage during movement. FIG. 4B shows an oval-shaped or substantially oval shaped consumable. In some examples, the aerosol generation consumable 100 is coin-shaped.

FIGS. 4C to 4E show an aerosol generation consumable 100 that is a polygon shaped with rounded corners.

FIG. 4C shows a consumable that is square shaped with rounded edges. FIG. 4D shows a pentagon that is substantially pentagon shaped with rounded edges. FIG. 4E is substantially hexagon shaped with rounded edges.

Rounded periphery means that when viewed on plan, e.g., the view shown in FIGS. 4A to 4E, there are no pointed corners on the aerosol generation consumable 100. In other words, an external face of the aerosol generation consumable does not have pointed corners. The external boundary of the aerosol generation consumable may have a smooth curved surface.

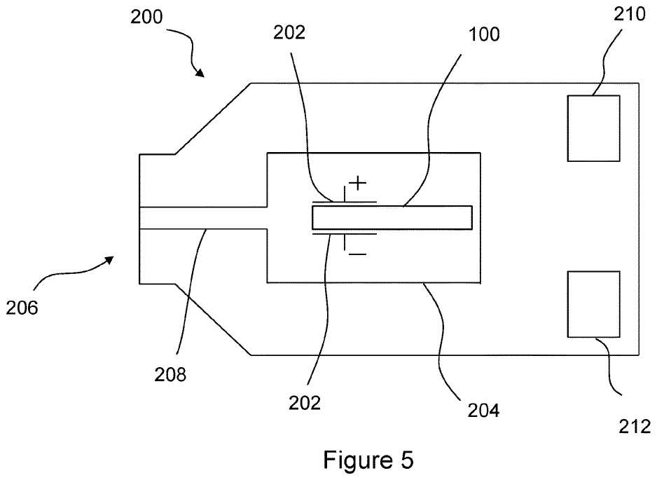

FIG. 5 shows a schematic cross-sectional view of an aerosol generation device 200 for use with the aerosol generation consumable 100 as described above. The aerosol generation device 200 may include a chamber 204 in which the aerosol generation consumable 100 is received.

As described above, the aerosol generation device 200 includes at least one electrode 202 configured to provide an electric power to the aerosol generation consumable 200, in use. In one example, the at least one electrode 202 is integral with an internal wall of the chamber 104. In other examples, the at least one electrode 202 extends into the chamber 104. The at least one electrode 202 is configured to be in direct contact with the aerosol generation consumable 100, in use. In one example, the aerosol generation consumable 100 is pressed between the at least two electrodes 202 (or one electrode and the grounded element). In some examples, the plan shape of an electrode 202 is substantially identical to the plan shape of the aerosol generation consumable 100.

The aerosol generation device 200 may include a mouthpiece 206 through which a user draws on the aerosol generation device 200 to inhale generated aerosol. The mouthpiece 206 includes a vent or channel 208 that is connected to a region close to the aerosol generation consumable 100 for passage of any generated aerosol from the aerosol generation consumable 100, during use. For example, the channel 208 may extend between an opening in the mouthpiece 206 and the chamber 204 in which the aerosol generation consumable 100 is receivable. The mouthpiece 206 is arranged such it may be received in a user's mouth in use.

The aerosol generation device 200 may also include a control unit 210 (or control circuitry) for electronic management of the device. The control unit 210 may include a PCB or the like (not shown). The control unit 210 is configured to control the electrodes 202 and hence the amount of electric power provided to the aerosol generation consumable 100, for example by controlling the amount of electric power provided to the electrodes 202. In other words, each of the electrodes 202 are arranged to provide (e.g., different) electrode potentials, in order to control the amount of electric power provided to the aerosol generation consumable 100. One electrode potential could be zero, or ground. The control unit 218 may be configured to receive data from various sensors/inputs and control the operation of the aerosol generation device 200 based on the received data.

In one example, the aerosol generation device 200 includes an activation input sensor 212. The activation input sensor 212 may be a button, a touchpad, or the like for sensing a user's input such as a tap or swipe. In other examples, the activation input sensor 212 comprises an aerosol generation consumable sensor configured to detect if an aerosol generation consumable 100 has been inserted into the aerosol generation device 200. For example, the input sensor 212 may comprise an authenticity detector that is configured to detect if an aerosol generation consumable 100 comprising one or more electrical conductors 104 has been inserted into the aerosol generation device 200. The input sensor 212 may detect if the circuit between the at least two electrodes 202 is completed due to the presence of the aerosol generation consumable 100 comprising one or more electrical conductors 104 (or the circuit between the at least one electrode and grounded element). The user input may also comprise an inhalation action by a user.

The aerosol generation device 200 may include a power supply (not shown) such as a battery. The power supply may provide the aerosol generation device 200 with electrical energy providing a voltage in range of 1 V and 8 V. In a preferred embodiment the voltage source is a lithium-ion battery delivering a value of 3.7 V. Such a voltage source is particularly advantageous for a modern aerosol generation device in view of rechargeability.

In one example, the aerosol generation consumable 100 may be arranged such that a plurality of aerosol generation consumables 100 are arranged in a stacked configuration. In this example, a plurality of stacked consumables could be inserted into a storage section of the aerosol generation device 200. The rounded periphery of the aerosol generation consumable 100 means that when stored in the aerosol generation device 200 they will be less prone to breakage. In addition, having a rounded periphery of the aerosol generation consumable, especially when disc-shaped, means that a plurality of aerosol generation consumable 100 may be conveniently stored in a substantially cylindrical arrangement, whether in packaging or within the aerosol generation device 200 itself. Alternatively, the aerosol generation consumable 100 may be stored individually in separate compartments of a packaging. This is particularly relevant to consumables 100 that have a smaller height (distance between planar faces) compared with the width (e.g., the diameter) with a rounded periphery. Such aerosol generation consumable 100 design allows simple stacking of multiple consumables 100 in the device 100, which, for example, helps to remove the necessity from the user to carry a separate package of consumables as all of the consumable could be inside the device in certain implementations.

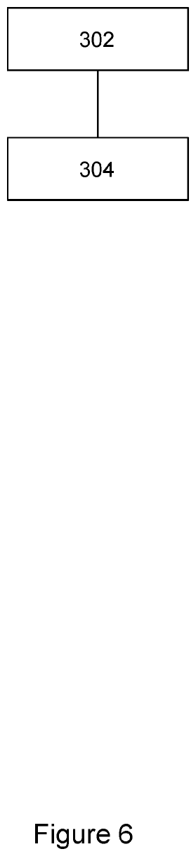

FIG. 6 shows a flow chart of steps for generating an aerosol. At step 300, the method includes the step of situating an aerosol generation consumable 100 in electrical contact with the electrodes 202 of an aerosol generation device 200. For example, a user may move the aerosol generation consumable 100 manually to be in position to be in electrical contact with the electrodes 202 of the aerosol generation device 200. Alternatively, an actuator of the aerosol generation device 200 may move the aerosol generation consumable 100 to be in electrical contact with the electrodes of the aerosol generation device 200. In some examples, the electrodes 202 of the aerosol generation device are movable from a first position in which they are in contact with the aerosol generation consumable 100 and a second position in which they are not in contact with the aerosol generation consumable 100. Step 302 relates to the provision of electrical power to the aerosol generation consumable 100. Aerosol is generated by the aerosol generation consumable 100 upon the application of electrical power.

Although preferred embodiments have been shown and described, it will be appreciated by those skilled in the art that various changes and modifications might be made without departing from the scope of the invention, as defined in the appended claims and as described above.

1. An aerosol generation consumable for use in an aerosol generation device, the aerosol generation consumable comprising:
aerosol precursor material and
one or more electrical conductors in the aerosol precursor material,
wherein the aerosol generation consumable has a rounded periphery, and
wherein the aerosol generation consumable is disc-shaped.

2. The aerosol generation consumable according to claim 1, further comprising one or more electrical contacts configured to electrically couple to electrodes of an aerosol generation device.

3. The aerosol generation consumable according to claim 2, wherein the one or more electrical contacts are arranged on a part of a periphery of the consumable.

4. The aerosol generation consumable according to claim 2, wherein the one or more electrical contacts are arranged on a planar surface of the aerosol precursor material.

5. The aerosol generation consumable according to claim 4, wherein the one or more electrical contacts comprises a first sheet on a first face of the aerosol precursor material and a second sheet on a second face of the aerosol precursor material.

6. The aerosol generation consumable according to claim 5, wherein one or more of the first sheet and the second sheet comprises one or more openings.

7. The aerosol generation consumable according to claim 2, wherein the one or more electrical contacts comprises a first electrical contact and a second electrical contact, wherein the aerosol generation consumable comprises an electrical insulator located at least part way between the first electrical contact and the second electrical contact.

8. The aerosol generation consumable according to claim 7, wherein the electrical insulator is paper based.

9. The aerosol generation consumable according to claim 1, wherein a thickness of the aerosol generation consumable is less than a width of the aerosol generation consumable.

10. A plurality of the aerosol generation consumables according to claim 1, wherein the plurality of the aerosol generation consumables are arranged in a stacked configuration.

11. A system comprising:
an aerosol generation device comprising at least one electrode configured to provide electrical power; and
the aerosol generation consumable according to claim 1 configured to receive the provided electrical power.

12. A method of generating an aerosol comprising:
situating the aerosol generation consumable according to claim 1, in electrical contact with at least one electrode of an aerosol generation device and
providing electrical power to the aerosol generation consumable.
